(19) United States
(12) Patent Application Publication
(10) Pub. No.: US 2018/0021927 A1
(43) Pub. Date: Jan. 25, 2018

(54) FIRMLY GRASPABLE SOCKET

(71) Applicant: Chia-Szu LIN, Taichung City (TW)

(72) Inventor: Chia-Szu LIN, Taichung City (TW)

(21) Appl. No.: 15/217,006

(22) Filed: Jul. 22, 2016

(51) Int. Cl. B25B 13/06; B25B 19/00; B25B 13/46

(52) U.S. Cl. CPC B25B 13/06; B25B 13/46; B25B 19/00

(57) ABSTRACT

A socket has a socket section and an assembling section connected to the socket section. The socket section is cylindrical and has an axial direction, a peripheral surface, a first end, a second end, a socket hole, and a grasp portion. The first end and the second end of the socket section are opposite each other in the axial direction of the socket section. The socket hole is axially defined in the first end of the socket section. The grasp portion is annularly concaved in the peripheral surface of the socket section and has a cross-section being along a diametrical surface of the socket section. The cross-section of the grasp portion has two opposite curved edges. The assembling section is coaxially connected to the second end of the socket section. The concave grasp portion makes the socket easily and securely grasped.

### BACKGROUND OF THE INVENTION

### 1. Field of the Invention

The present invention relates to a hand tool, and more particularly to a firmly graspable socket that can be steadily held in hands.

### 2. Description of Related Art

A socket is utilized with a ratchet or an impact wrench to loosen or fasten screws or nuts. The socket has two opposite ends. One of the two opposite ends of the socket is assembled on the ratchet or the impact wrench. By operating the ratchet or the impact wrench, the socket is rotated to loosen or fasten the screws or the nuts.

The conventional socket is cylindrical and has a peripheral surface which is slippery. The conventional socket is easily slipped off hands of a user and is difficult to be thinly grasped. Moreover, some conventional sockets of large sizes are heavy as well. The conventional sockets of large sizes and heavy weights are uneasy to be held by one hand. As the peripheral surface of the conventional socket or a glove worn by hand is stained by grease for lubrication, the self weight and the slippery peripheral surface of the conventional socket make the conventional socket even more easily slipped off the hand. The conventional socket slipped off the hands likely injures the user and raises safety concerns.

To overcome the shortcomings of the conventional socket, the present invention provides a firmly graspable socket to mitigate or obviate the aforementioned problems.

### SUMMARY OF THE INVENTION

The main objective of the present invention is to provide a firmly graspable socket that can be secularly held in hands for a safer usage experience of the socket.

The socket comprises a socket section and an assembling section connected to the socket section. The socket section is cylindrical and has an axial direction, a peripheral surface, a first end, a second end, a socket hole, and a grasp portion. The first end and the second end of the socket section are opposite each other in the axial direction of the socket section. The socket hole is axially defined in the first end of the socket section. The grasp portion is annularly concaved in the peripheral surface of the socket section and has a cross-section being along a diametrical surface of the socket section. The cross-section of the grasp portion has two opposite curved edges. The assembling section is coaxially connected to the second end of the socket section. The concave grasp portion makes the socket easily and securely grasped.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of a socket in accordance with the present invention;

FIG. 2 is a cross-sectional side view of the socket in FIG. 1;

FIG. 3 is an operational side view of the socket in FIG. 1;

FIG. 4 is a perspective view of a second embodiment of a socket in accordance with the present invention;

FIG. 5 is a cross-sectional side view of a third embodiment of a socket in accordance with the present invention, showing a lowest point; and

FIG. 6 is a cross-sectional side view of a fourth embodiment of a socket in accordance with the present invention, showing that the lowest point is located at a different position.

### DETAILED DESCRIPTION OF PREFERRED EMBODIMENT

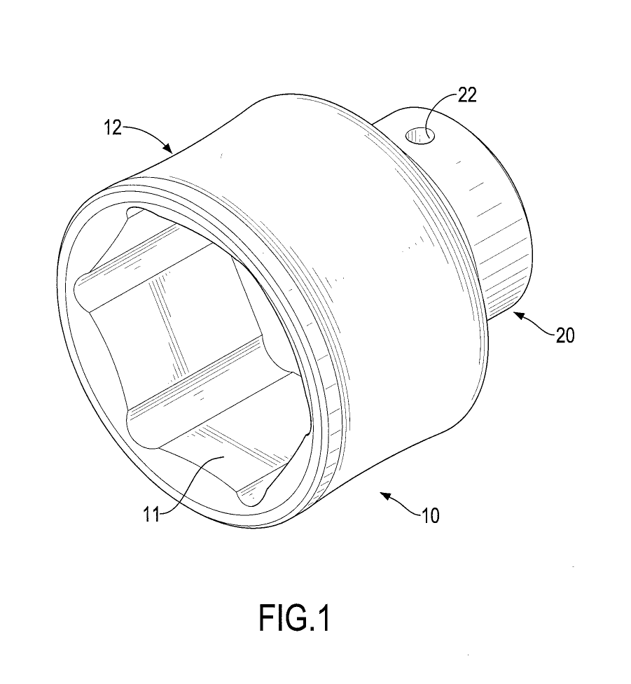

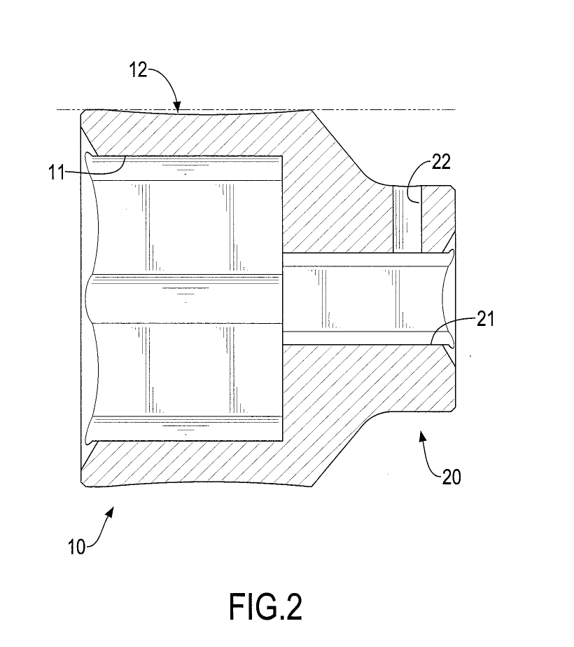

With reference to FIGS. 1 and 2, a socket in accordance with the present invention comprises a socket section 10 and an assembling section 20. The assembling section 20 is connected to the socket section 10.

With reference to FIGS. 1 and 2, the socket section 10 is utilized to mount around a nut or a screw. The socket section 10 is cylindrical and has an axial direction, a radial direction, a peripheral surface, a first end, a second end, a socket hole 11, and a grasp portion 12. The first end and the second end of the socket section 10 are opposite each other in the axial direction of the socket section 10. The socket hole 11 is axially defined in the first end of the socket section 10. The socket hole 11 extends toward the second end of the socket section 10 and has a bottom. The socket hole 11 has a hexagonal outline. The grasp portion 12 is annularly concaved in the peripheral surface of the socket section 10 and has a cross-section along a diametrical surface of the socket section 10. The cross-section of the grasp portion 12 has two opposite curved edges.

With reference to FIGS. 1 and 2, the assembling section 20 is coaxially connected to the second end of the socket section 10 and has an exterior surface, a flat end face, an assembling hole 21, and a through hole 22. The assembling hole 21 is defined inside the assembling section 20, coaxially communicates with the socket hole 11 of the socket section 10, and extends from the bottom of the socket hole 11 to the flat end face of the assembling section 20. The assembling hole 21 is utilized to assemble with a ratchet or an impact wrench. The through hole 22 is defined in the exterior surface of the assembling section 20 along the radial direction of the socket section 10 and communicates with the assembling hole 21.

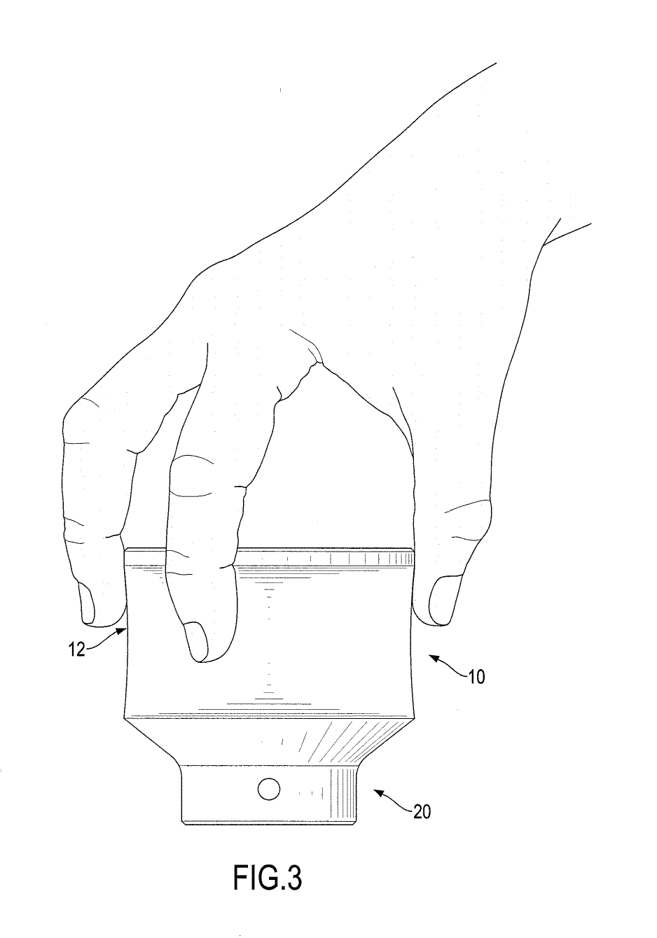

With reference to FIG. 3, the grasp portion 12 of the socket section 10 may be grabbed by the thumb and the fingers, or alternatively, the grasp portion 12 may be held in the thumb-index web space of the hand. The grasp portion 12 is concave, ensuring that the socket can be securely grasped and the chance of the socket slipping off the hand is lowered.

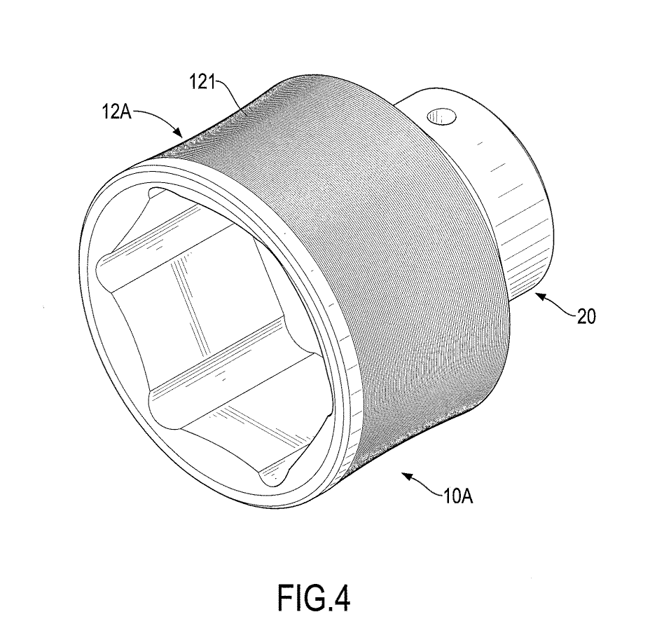

With reference to FIG. 4, the second embodiment in accordance with the present invention has the socket section 10A and the assembling section 20. The grasp portion 12A of the second embodiment has multiple slip-proof grooves 121. The multiple slip-proof grooves 121 are annularly formed in the peripheral surface of the socket section 10A. The multiple slip-proof grooves 121 are closely distributed on the peripheral surface of the socket section 10A. The multiple slip-proof grooves 121 increase the friction between the grasp portion 12A and the hand holding the socket and further lower the chance of slipping the socket off the hand.

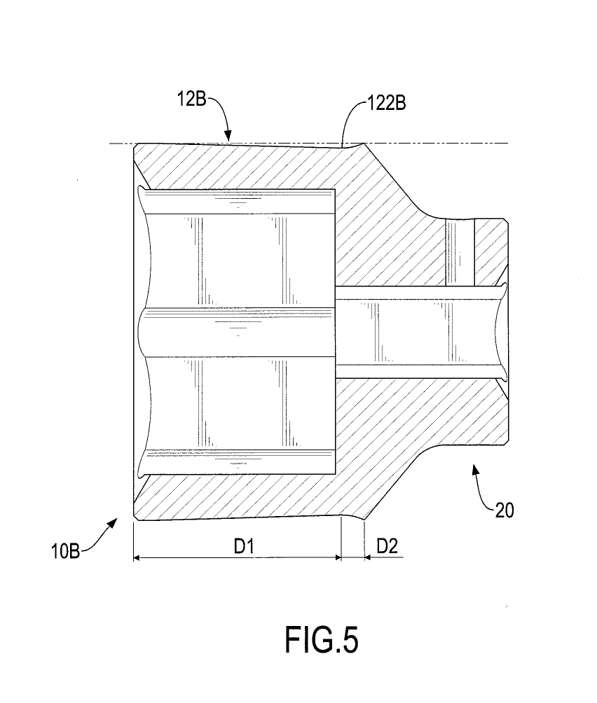

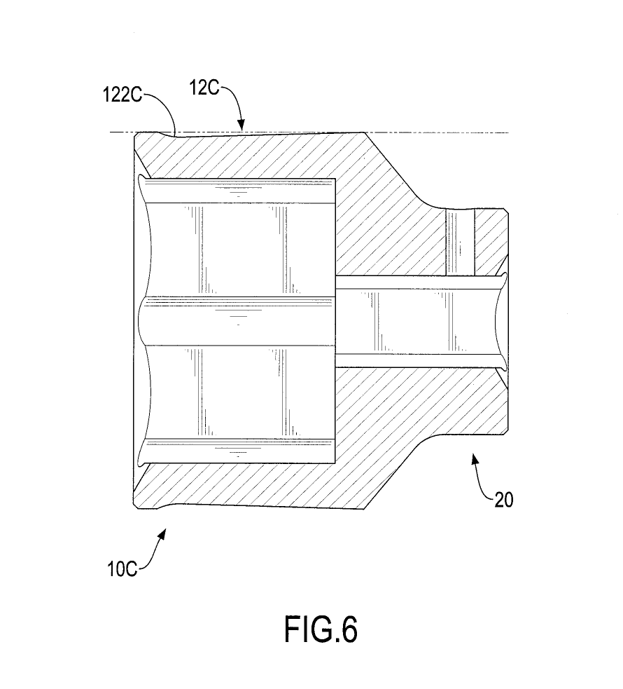

With reference to FIG. 5, the third embodiment in accordance with the present invention has the socket section 10B and the assembling section 20. Each one of the two curved edges of the grasp portion 12B has a lowest point 122B. The lowest point 122B of each curved edge is spaced from the first end and the second end of the socket section 10B respectively by a first distance D1 and a second distance D2. The first distance D1 is larger than the second distance D2. The lowest point 122B is adjacent to the second end of the socket section 10B to form multiple curvatures in the concave grasp portion 12B. Alternatively, with reference to FIG. 6, the lowest point 122C of the grasp portion 12C may be adjacent to the first end of the socket section 10C, and the first distance D1 is smaller than the second distance D2.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A socket comprising:
a socket section being cylindrical and having
an axial direction;
a peripheral surface;
a first end;
a second end opposite the first end of the socket section in the axial direction of the socket section;
a socket hole axially defined in the first end of the socket section and having a bottom; and
a grasp portion annularly concaved in the peripheral surface of the socket section and having
a cross-section being along a diametrical surface of the socket section and having two opposite curved edges; and
an assembling section coaxially connected to the second end of the socket section and having
an assembling hole defined in the bottom of the socket hole, defined through the assembling section, and coaxially communicating with the socket hole.

2. The socket as claimed in claim 1, wherein the grasp portion has multiple slip-proof grooves annularly formed in the peripheral surface of the socket section and closely distributed on the peripheral surface of the socket section.

3. The socket as claimed in claim 2, wherein
the socket section has a radial direction perpendicular to the axial direction of the socket section; and
the assembling section has
an exterior surface; and
a through hole defined in the exterior surface of the assembling section along the radial direction of the socket section and communicating with the assembling hole.

4. The socket as claimed in claim 3, wherein each one of the two curved edges of the cross-section of the grasp portion has a lowest point adjacent to the second end of the socket section.

5. The socket as claimed in claim 2, wherein each one of the two curved edges of the cross-section of the grasp portion has a lowest point adjacent to the second end of the socket section.

6. The socket as claimed in claim 1, wherein each one of the two curved edges of the cross-section of the grasp portion has a lowest point adjacent to the second end of the socket section.

7. The socket as claimed in claim 1, wherein each one of the two curved edges of the cross-section of the grasp portion has a lowest point adjacent to the first end of the socket section.
